(19) United States
(12) Patent Application Publication
(10) Pub. No.: US 2022/0277881 A1
(43) Pub. Date: Sep. 1, 2022

(54) TRANSFORMER

(71) Applicant: DIAMOND&ZEBRA ELECTRIC MFG. CO., LTD., Osaka (JP)

(72) Inventors: Takashi MASADOME, Osaka (JP); Yuuki OOKADO, Osaka (JP)

(73) Assignee: DIAMOND&ZEBRA ELECTRIC MFG. CO., LTD., Osaka (JP)

(21) Appl. No.: 17/586,026

(22) Filed: Jan. 27, 2022

(30) Foreign Application Priority Data
Feb. 26, 2021 (JP) 2021-030544

(51) Int. Cl. H01F 27/02; H01F 27/29; H01F 27/24; H01F 27/16; H01F 27/40

(52) U.S. Cl. CPC H01F 27/025; H01F 27/29; H01F 27/24; H01F 27/16; H01F 27/40; H01F 2027/408

(57) ABSTRACT

In a transformer, forward and reverse secondary coils are connected to a single reference electrode or any of a plurality of reference electrodes. The forward secondary coil includes first and second winding portions wound around a forward iron core. The reverse secondary coil includes third and fourth winding portions wound around a reverse iron core. A first primary coil is formed around the first and third winding portions. The second primary coil is formed around the second and fourth winding portions. The single reference electrode or each of the plurality of reference electrodes is in the form of a plate.

### CROSS-REFERENCE TO RELATED APPLICATION

This application claims priority on and the benefit of Patent Application No. 2021-030544 filed in JAPAN on Feb. 26, 2021. The entire disclosures of this Japanese Patent Application are hereby incorporated by reference.

### BACKGROUND OF THE INVENTION

### Field of the Invention

The present specification discloses a transformer. In particular, the present invention relates to a current-doubler transformer.

### Description of the Related Art

In recent years, current-doubler transformers have been used as DC-DC converters or AC-DC converters. Such a transformer includes two secondary coils that output voltages inverse to each other according to changes in the input voltage applied to a primary coil. One of the secondary coils is herein referred to as “forward secondary coil”, and the other secondary coil is herein referred to as “reverse secondary coil”. For example, when the output of the forward secondary coil is a positive voltage, the output of the reverse secondary coil is a negative voltage. The respective outputs of the secondary coils are connected to rectifying elements such as diodes, and these rectifying elements are connected to an output terminal. Thus, for example, the output of the forward secondary coil is output through the output terminal, and the reverse secondary coil is isolated from the output terminal.

In the transformer, when one of the secondary coils is isolated from the output terminal, energy is stored in the one secondary coil during the period of isolation. In the example mentioned above, energy is stored in the reverse secondary coil. Once the output voltage of the reverse secondary coil becomes a positive voltage in response to a change in the input voltage applied to the primary coil, the voltage from the reverse secondary coil is output through the output terminal. In this situation, the output current is high due to the energy arising from an induced electromotive force and the stored energy. A study about current-doubler transformers is disclosed in “A Novel Integrated Current Doubler Rectifier”, APEC 2000, Fifteenth Annual IEEE Applied Power Electronics Conference and Exposition.

Current-doubler transformers generate a large amount of heat because of high currents flowing through the transformers. Equipping the housings of the transformers with additional means such as radiating fins to reduce the temperature rise induced by the heat generation leads to increases in size and cost of the transformers. There is a demand for a transformer in which heat generation-induced temperature rise is reduced by a simple configuration.

The present inventors aim to provide a current-doubler transformer in which heat generation-induced temperature rise is reduced by a simple configuration.

### SUMMARY OF THE INVENTION

A preferred transformer includes: a positive-side input electrode; a negative-side input electrode; an output electrode; a single reference electrode or a plurality of reference electrodes; a forward iron core; a reverse iron core; a first primary coil; a second primary coil; a forward secondary coil; a reverse secondary coil; a first rectifying element; and a second rectifying element. A first terminal of the first primary coil is connected to the positive-side input electrode, and a second terminal of the first primary coil is connected to the negative-side input electrode. A first terminal of the second primary coil is connected to the positive-side input electrode, and a second terminal of the second primary coil is connected to the negative-side input electrode. A first terminal of the forward secondary coil is connected to a first terminal of the first rectifying element, and a second terminal of the forward secondary coil is connected to the single reference electrode or any of the plurality of reference electrodes. A first terminal of the reverse secondary coil is connected to a first terminal of the second rectifying element, and a second terminal of the reverse secondary coil is connected to the single reference electrode or any of the plurality of reference electrodes. Second terminals of the first and second rectifying elements are connected to the output electrode. The forward secondary coil includes first and second winding portions both of which are wound around the forward iron core. The reverse secondary coil includes third and fourth winding portions both of which are wound around the reverse iron core. The first primary coil is formed around the first and third winding portions. The second primary coil is formed around the second and fourth winding portions. The single reference electrode or each of the plurality of reference electrodes is in the form of a plate. Winding directions of the first and second primary coils and the first, second, third, and fourth winding portions are defined so that voltages inverse to each other are generated at the respective first terminals of the forward and reverse secondary coils upon a change in a voltage applied between the positive-side and negative-side input electrodes. The voltage of the first terminal of the forward or reverse secondary coil is output through the output electrode by bringing one of the first and second rectifying elements into a conducting state while bringing the other of the first and second rectifying elements into a non-conducting state.

The transformer includes the forward secondary coil, the reverse secondary coil, the forward iron core around which the forward secondary coil is wound, the reverse iron core around which the reverse secondary coil is wound, and the single reference electrode or the plurality of reference electrodes. The single reference electrode or each of the plurality of reference electrodes is in the form of a plate. In such a reference electrode, the cross-sectional area contributing to thermal conduction and the surface area contributing to heat release can easily be increased. The reference electrode effectively discharges heat generated in the secondary coils and iron cores. In the transformer, heat generation-induced temperature rise is reduced by a simple configuration.

### BRIEF DESCRIPTION OF THE DRAWINGS

FIG. 1 is a perspective view showing a transformer according to one embodiment.

FIG. 2 is a plan view showing the transformer of FIG. 1 with a top cover, a bottom cover, and joints removed.

FIG. 3 is an equivalent circuit diagram of the transformer of FIG. 1.

FIG. 4A is a perspective view showing an iron core of the transformer of FIG. 1, and FIG. 4B is an exploded view showing the iron cone.

FIG. 5 is a perspective view showing secondary coils of the transformer of FIG. 1.

FIG. 6 is a perspective view showing the secondary coils, iron cores, and a reference electrode of the transformer of FIG. 1.

FIG. 7 is a plan view of the secondary coils, iron cores, and reference electrode of FIG. 6.

FIG. 8 is a perspective view showing the reference electrode of the transformer of FIG. 1.

FIG. 9A is a perspective view showing a primary coil of the transformer of FIG. 1, and FIG. 9B is a cross-sectional view taken along the line IXb-IXb of FIG. 9A.

FIG. 10 is a perspective view showing the top cover, bottom cover, and joints of the transformer of FIG. 1.

FIG. 11 is a plan view showing secondary coils according to another embodiment.

FIG. 12 is a perspective view showing iron cores, primary coils, secondary coils, and reference electrodes of a transformer according to yet another embodiment.

FIG. 13 is a plan view showing the secondary coils and reference electrodes of the transformer of FIG. 12.

### DESCRIPTION OF THE PREFERRED EMBODIMENTS

The following will describe in detail the present invention based on preferred embodiments with appropriate reference to the drawings.

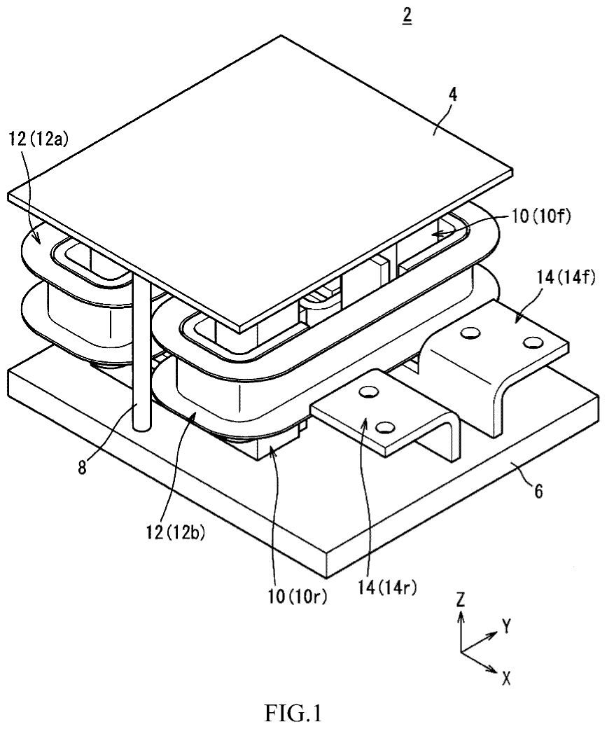

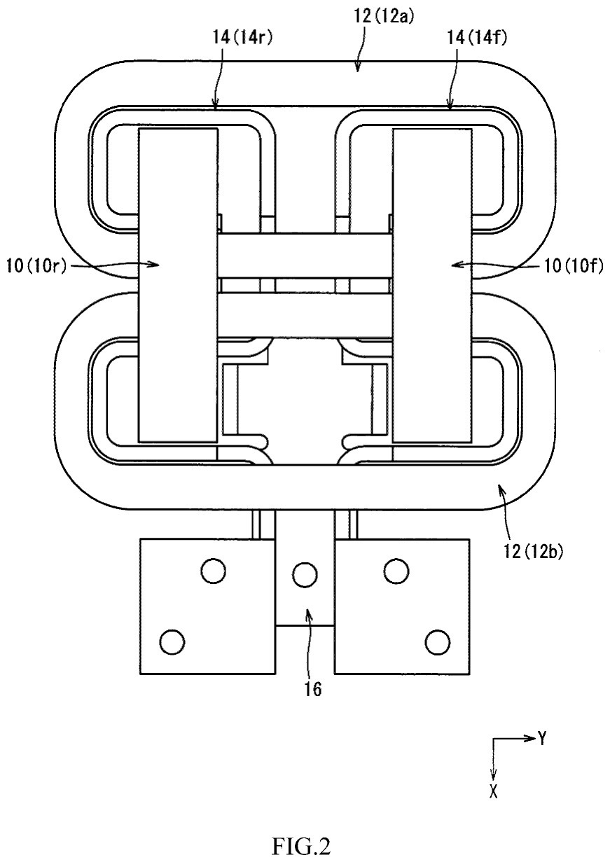

FIG. 1 is a perspective view showing a transformer 2 according to one embodiment. In FIG. 1, the arrow X represents the frontward direction with respect to the transformer 2, and the opposite direction is the backward direction with respect to the transformer 2. The arrow Y represents the rightward direction with respect to the transformer 2, and the opposite direction is the leftward direction with respect to the transformer 2. The arrow Z represents the upward direction with respect to the transformer 2, and the opposite direction is the downward direction with respect to the transformer 2. The transformer 2 includes a top cover 4, a bottom cover 6, joints 8, iron cores 10, primary coils 12, and secondary coils 14. FIG. 2 is a plan view showing the transformer 2 of FIG. 1 with the top cover 4, bottom cover 6, and joints 8 removed. The transformer 2 further includes a reference electrode 16.

As shown in FIGS. 1 and 2, the transformer 2 includes two iron cores 10, two secondary coils 14, and two primary coils 12. As described later, the output voltage of one of the secondary coils 14 and the output voltage of the other secondary coil 14 are inverse to each other. Thus, in this specification, one of the two secondary coils 14 is referred to as “forward secondary coil 14f”, and the other secondary coil 14 is referred to as “reverse secondary coil 14r”. Either of the two secondary coils 14 may be referred to as “forward secondary coil”, although in this embodiment the right secondary coil 14 in FIGS. 1 and 2 is referred to as “forward secondary coil”. The iron core 10 around which the forward secondary coil 14f is wound is referred to as “forward iron core 10f”, and the iron core 10 around which the reverse secondary coil 14r is wound is referred to as “reverse iron core 10r”. One of the two primary coils 12 is referred to as “first primary coil 12a”, and the other primary coil 12 is referred to as “second primary coil 12b”.

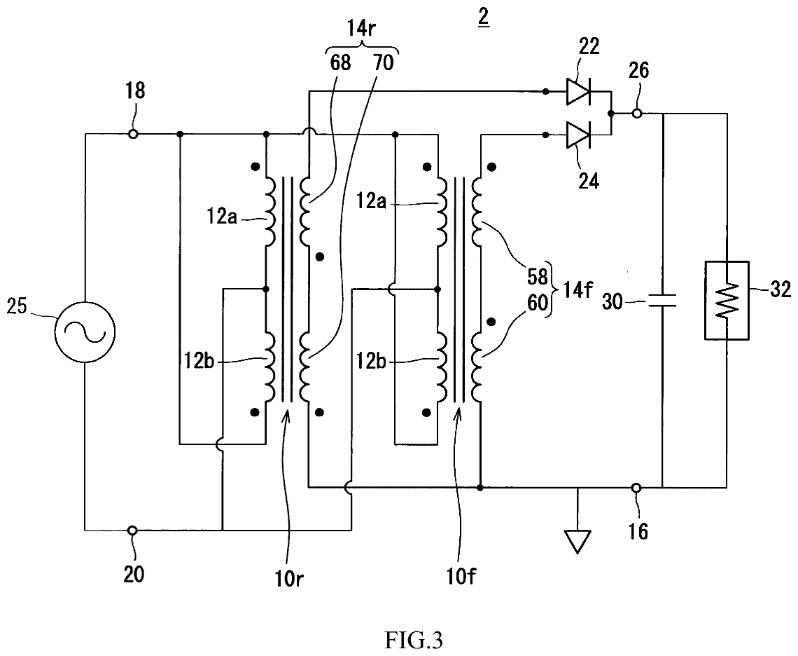

FIG. 3 shows an equivalent circuit of the transformer 2 of FIG. 1. Although not shown in FIGS. 1 and 2, the transformer 2 further includes a positive-side input electrode 18, a negative-side input electrode 20, a first rectifying element 22, a second rectifying element 24, and an output electrode 26. The top cover 4, bottom cover 6, and joints 8 are not illustrated in the circuit diagram of FIG. 3. The following are also shown in the circuit diagram of FIG. 3: an AC power supply 25 connected to the positive-side and negative-side input electrodes 18 and 20 of the transformer 2; and a capacitor 30 and load 32 that are connected to the output electrode 26 and reference electrode 16 of the transformer 2.

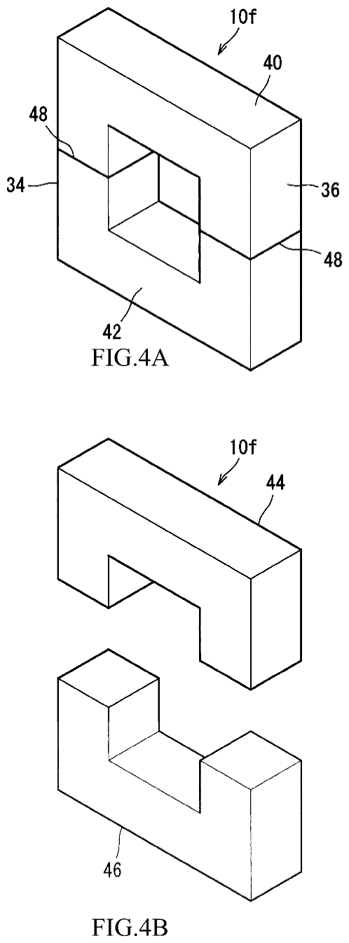

FIG. 4A is a perspective view showing the forward iron core 10f of FIG. 1. The forward iron core 10f is in the form of a frame having outer and inner peripheral surfaces with rectangular contours. Thus, the forward iron core 10f includes opposing first and second pillar portions 34 and 36 extending parallel to each other and opposing third and fourth pillar portions 40 and 42 extending parallel to each other and perpendicular to the first and second pillar portions 34 and 36.

As shown in FIG. 4B, the forward iron core 10f is formed of half frame-shaped first and second halves 44 and 46 combined with each other. There are gaps between the first and second halves 44 and 46. In other words, the forward iron core 10f includes two cut portions 48. In this embodiment, one of the cut portions 48 is located in the first pillar portion 34, and the other cut portion 48 is located in the second pillar portion 36. The forward iron core 10f is made of a magnetic material. Typically, the forward iron core 10f is made of ferrite. The forward iron core 10f may be made of an amorphous magnetic material or silicon steel.

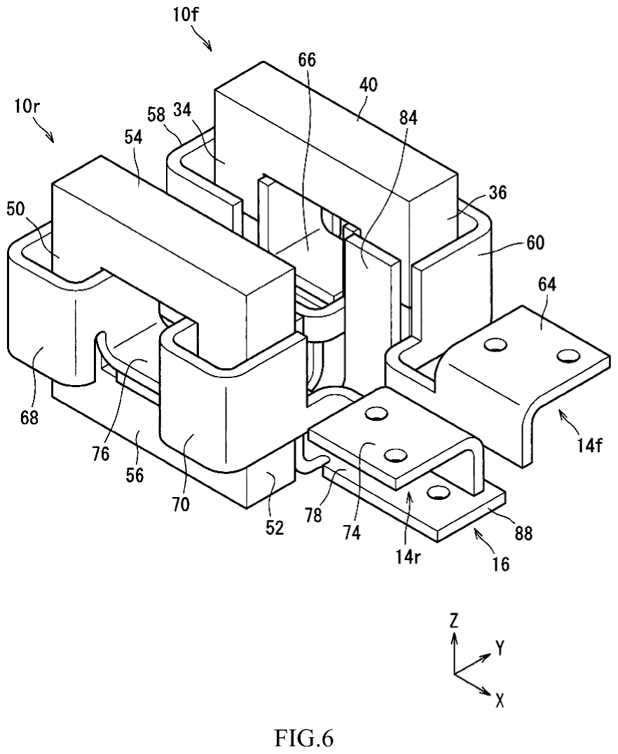

The reverse iron core 10r has the same structure as the forward iron core 10f. That is, the reverse iron core 10r is in the form of a frame having outer and inner peripheral surfaces with rectangular contours. Thus, the reverse iron core 10r includes opposing first and second pillar portions 50 and 52 extending parallel to each other and opposing third and fourth pillar portions 54 and 56 extending parallel to each other and perpendicular to the first and second pillar portions 50 and 52 (see FIG. 6 described later). Although not shown, the reverse iron core 10r is formed of half frame-shaped first and second halves combined with each other. There are gaps between the first and second halves. The reverse iron core 10r includes two cut portions. In this embodiment, one of the cut portions is located in the first pillar portion 50, and the other cut portion is located in the second pillar portion 52. The reverse iron core 10r is made of a magnetic material. Typically, the reverse iron core 10r is made of ferrite. The reverse iron core 10r may be made of an amorphous magnetic material or silicon steel. As shown in FIG. 2, the forward and revers iron cores 10f and 10r are arranged side by side. When viewed in plan, the reverse iron core 10r is parallel to the forward iron core 10f.

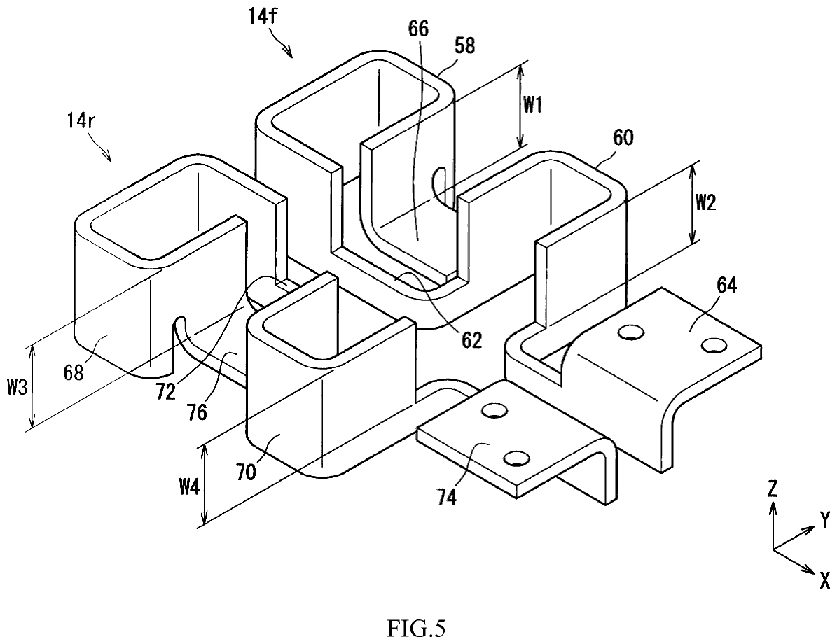

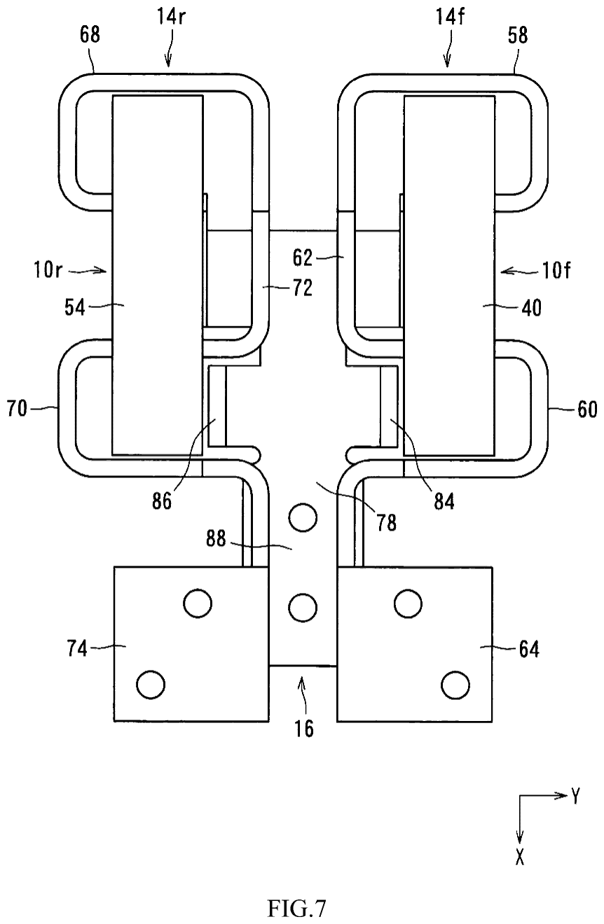

FIG. 5 is a perspective view showing the forward and reverse secondary coils 14f and 14r. FIG. 6 is a perspective view showing the forward and reverse secondary coils 14f and 14r combined with the forward and reverse iron cores 10f and 10r. FIG. 7 is a plan view of the forward and reverse secondary coils 14f and 14r and forward and reverse iron cores 10f and 10r shown in FIG. 6. The reference electrode 16 is also shown in FIGS. 6 and 7.

The forward secondary coil 14f is made of an electrically conductive material (conductor). The forward secondary coil 14f is typically made of a copper alloy or an aluminum alloy. As shown in FIG. 5, the forward secondary coil 14f includes a first winding portion 58, a second winding portion 60, a connection portion 62, a first terminal 64, and a second terminal 66. Each of the first and second winding portions 58 and 60 is a wound conductor in the form of a plate. As shown in FIGS. 6 and 7, the first winding portion 58 is wound around the first pillar portion 34 of the forward iron core 10f. The first winding portion 58 covers the cut portion 48 of the first pillar portion 34. The second winding portion 60 is wound around the second pillar portion 36 of the forward iron core 10f. The second winding portion 60 covers the cut portion 48 of the second pillar portion 36. In the present specification, being “electrically conductive” means having an electrical resistivity of 1.0×10⁻⁵ Ω/m or less.

In this embodiment, there are gaps between the forward iron core 10f and first winding portion 58 and between the forward iron core 10f and second winding portion 60. Although not shown, a thermally conductive insulator may be located on the first pillar portion 34 and between the first winding portion 58 and the outer or inner peripheral surface of the forward iron core 10f. That is, the first winding portion 58 may be in indirect contact with the outer or inner peripheral surface of the forward iron core 10f at the first pillar portion 34 via the thermally conductive insulator. A thermally conductive insulator may be located on the second pillar portion 36 and between the second winding portion 60 and the outer or inner peripheral surface of the forward iron core 10f. That is, the second winding portion 60 may be in indirect contact with the outer or inner peripheral surface of the forward iron core 10f at the second pillar portion 36 via the thermally conductive insulator. In the present specification, being “thermally conductive” means having a thermal conductivity of 1.0 W/m·K or more.

The connection portion 62 connects the first and second winding portions 58 and 60. The connection portion 62 extends parallel to the third and fourth pillar portions 40 and 42 of the forward iron core 10f. The first terminal 64 is in the form of a plate. The first terminal 64 projects ahead of the second winding portion 60. The second terminal 66 is in the form of a plate. The second terminal 66 is located between the first and second winding portions 58 and 60. The second terminal 66, first winding portion 58, connection portion 62, second winding portion 60, and first terminal 64 are connected in series in this order.

As shown in FIGS. 5 and 7, the first and second winding portions 58 and 60 are wound in opposite directions. Since the first and second pillar portions 34 and 36 are opposed to each other, the magnetic fluxes in the first and second pillar portions 34 and 36 flow in opposite directions. Thus, the induced electromotive forces occurring in the first and second winding portions 58 and 60 in response to changes in the magnetic fluxes in the forward iron core 10f act in the same direction. The voltage generated between the first and second terminals 64 and 66 of the forward secondary coil 14f due to the induced electromotive forces is the sum of the voltage generated in the first winding portion 58 and the voltage generated in the second winding portion 60. Thus, in the circuit diagram of FIG. 3, the forward secondary coil 14f is depicted as having a structure in which the coil corresponding to the first winding portion 58 and the coil corresponding to the second winding portion 60 are connected in series.

The reverse secondary coil 14r is made of a conductor. The reverse secondary coil 14r is typically made of a copper alloy or an aluminum. As shown in FIG. 5, the reverse secondary coil 14r includes a third winding portion 68, a fourth winding portion 70, a connection portion 72, a first terminal 74, and a second terminal 76. Each of the third and fourth winding portions 68 and 70 is a wound conductor in the form of a plate. As shown in FIGS. 6 and 7, the third winding portion 68 is wound around the first pillar portion 50 of the reverse iron core 10r. The third winding portion 68 covers the cut portion of the first pillar portion 50. The fourth winding portion 70 is wound around the second pillar portion 52 of the reverse iron core 10r. The fourth winding portion 70 covers the cut portion of the second pillar portion 52.

In this embodiment, there are gaps between the reverse iron core 10r and third winding portion 68 and between the reverse iron core 10r and fourth winding portion 70. Although not shown, a thermally conductive insulator may be located on the first pillar portion 50 and between the third winding portion 68 and the outer or inner peripheral surface of the reverse iron core 10r. That is, the third winding portion 68 may be in indirect contact with the outer or inner peripheral surface of the reverse secondary coil 14r at the first pillar portion 50 via the thermally conductive insulator. A thermally conductive insulator may be located on the second pillar portion 52 and between the fourth winding portion 70 and the outer or inner peripheral surface of the reverse iron core 10r. That is, the fourth winding portion 70 may be in indirect contact with the outer or inner peripheral surface of the reverse iron core 10r at the second pillar portion 52 via the thermally conductive insulator.

The connection portion 72 connects the third and fourth winding portions 68 and 70. The connection portion 72 extends parallel to the third and fourth pillar portions 54 and 56 of the reverse iron core 10r. The first terminal 74 is in the form of a plate. The first terminal 74 projects ahead of the fourth winding portion 70. The second terminal 76 is in the form of a plate. The second terminal 76 is located between the third and fourth winding portions 68 and 70. The second terminal 76, third winding portion 68, connection portion 72, fourth winding portion 70, and first terminal 74 are connected in series in this order.

As shown in FIGS. 5 and 7, the third and fourth winding portions 68 and 70 are wound in opposite directions. Since the first and second pillar portions 50 and 52 are opposed to each other, the magnetic fluxes in the first and second pillar portions 50 and 52 flow in opposite directions. Thus, the induced electromotive forces occurring in the third and fourth winding portions 68 and 70 in response to changes in the magnetic fluxes in the reverse iron core 10r act in the same direction. The voltage generated between the first and second terminals 74 and 76 of the reverse secondary coil 14r due to the induced electromotive forces is the sum of the voltage generated in the third winding portion 68 and the voltage generated in the fourth winding portion 70. Thus, in the circuit diagram of FIG. 3, the reverse secondary coil 14r is depicted as having a structure in which the coil corresponding to the third winding portion 68 and the coil corresponding to the fourth winding portion 70 are connected in series.

As shown in FIGS. 6 and 7, the reverse secondary coil 14r is shaped such that when viewed in plan, the forward and reverse secondary coils 14f and 14r are symmetrical about a line extending in the front-back direction and bisecting the distance between the forward and reverse secondary coils 14f and 14r. That is, the first and third winding portions 58 and 68 are wound in opposite directions. The second and fourth winding portions 60 and 70 are wound in opposite directions.

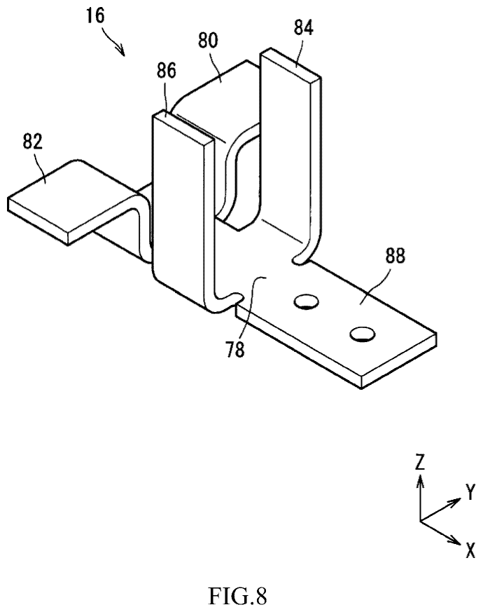

FIG. 8 is a perspective view showing the reference electrode 16. The reference electrode 16 is made of a conductor. The reference electrode 16 is typically made of a copper alloy or an aluminum alloy. The reference electrode 16 is generally in the form of a plate. As shown in FIGS. 6 and 7, the reference electrode 16 is located between the forward and reverse secondary coils 14f and 14r when viewed in plan. The reference electrode 16 is located between the forward and reverse iron cores 10f and 10r when viewed in plan. As shown in FIG. 8, the reference electrode 16 includes a base portion 78, a first extraction portion 80, a second extraction portion 82, a first side portion 84, and a second side portion 86.

As shown in FIGS. 6 and 7, the base portion 78 is located between the forward and reverse iron cores 10f and 10r and extends in the front-back direction. The base portion 78 extends along the fourth pillar portions 42 and 56 of the forward and reverse iron cores 10f and 10r. The base portion 78 includes a projecting portion 88 projecting outward from the space between the forward and reverse iron cores 10f and 10r. The base portion 78 is buried in the bottom cover 6. Thus, the base portion 78 is not seen in FIG. 1. The base portion 78 is in direct contact with the bottom cover 6. A thermally conductive insulator may be interposed between the base portion 78 and bottom cover 6. The base portion 78 may be in indirect contact with the bottom cover 6, with the insulator interposed therebetween.

The first and second extraction portions 80 and 82 and the first and second side portions 84 and 86 project upward from the bottom cover 6. The first extraction portion 80 extends from the base portion 78 toward the forward secondary coil 14f. The first extraction portion 80 is in contact with the second terminal 66 of the forward secondary coil 14f. Thus, as shown in the circuit diagram of FIG. 3, the forward secondary coil 14f is connected to the reference electrode 16. The second extraction portion 82 extends from the base portion 78 toward the reverse secondary coil 14r. The second extraction portion 82 is in contact with the second terminal 76 of the reverse secondary coil 14r. Thus, as shown in the circuit diagram of FIG. 3, the reverse secondary coil 14r is connected to the reference electrode 16. The first side portion 84 extends upward from the base portion 78. As shown in FIG. 6, the first side portion 84 extends along the second pillar portion 36 of the forward iron core 10f. Although not seen in FIG. 6, the second side portion 86 extends along the second pillar portion 52 of the reverse iron core 10r.

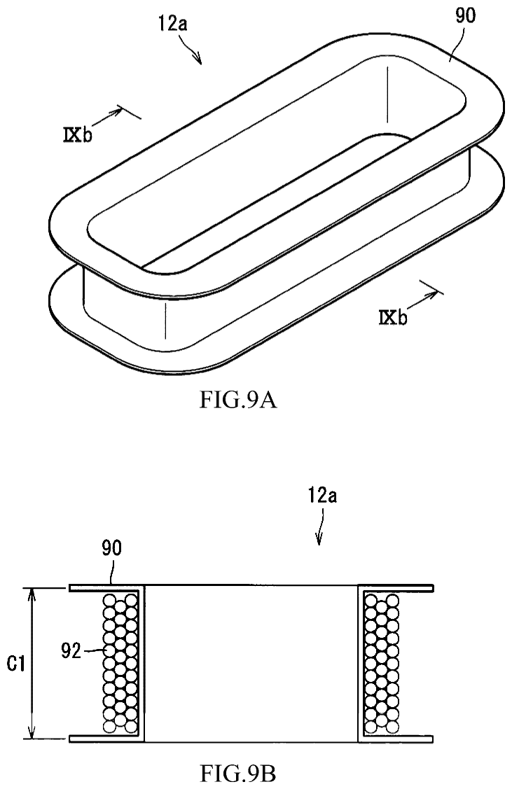

FIG. 9A is a perspective view showing the first primary coil 12a. FIG. 9B is a cross-sectional view taken along the line IXb-IXb of FIG. 9A. The first primary coil 12a includes a bobbin 90 and a wire 92. Although not shown, the first primary coil 12a further includes a first terminal connected to one end of the wire 92 and a second terminal connected to the other end of the wire 92. The bobbin 90 is in the form of a frame. The wire 92 is wound in a plurality of turns around the outer periphery of the bobbin 90. FIG. 9B shows a cross-section of the bobbin 90 and a cross-section of the wire 92 wound around the bobbin 90. A typical material of the wire 92 is copper (Cu).

The second primary coil 12b, like the first primary coil 12a, includes a bobbin, a wire, a first terminal, and a second terminal. The bobbin of the second primary coil 12b has the same structure as the bobbin 90 of the first primary coil 12a. The wire is wound in a plurality of turns around the outer periphery of the bobbin. In this embodiment, the wire of the second primary coil 12b is wound in a direction opposite to that in which the wire 92 of the first primary coil 12a is wound.

In the transformer 2, as shown in FIGS. 1 and 2, the first and third winding portions 58 and 68 are arranged side by side. The frame-shaped first primary coil 12a is disposed to surround the first and third winding portions 58 and 68. In other words, the first primary coil 12a is formed around the first and third winding portions 58 and 68.

In FIG. 9, the double-headed arrow C1 represents the width of the first primary coil 12a. In FIG. 5, the double-headed arrow W1 represents the width of the first winding portion 58, and the double-headed arrow W3 represents the width of the third winding portion 68. The width C1 of the first primary coil 12a is similar to the widths W1 and W3 of the first and third winding portions 58 and 68. The first primary coil 12a is wound outside the first winding portion 58 over substantially the entire width of the first winding portion 58. The first primary coil 12a is wound outside the third winding portion 68 over substantially the entire width of the third winding portion 68. In the present specification, the statement that “two widths are similar” means that the ratio between the two widths is from 0.80 to 1.25.

In the transformer 2, as shown in FIGS. 1 and 2, the second and fourth winding portions 60 and 70 are arranged side by side. The frame-shaped second primary coil 12b is disposed to surround the second and fourth winding portions 60 and 70. In other words, the second primary coil 12b is formed around the second and fourth winding portions 60 and 70.

In FIG. 5, the double-headed arrow W2 represents the width of the second winding portion 60, and the double-headed arrow W4 represents the width of the fourth winding portion 70. The width of the second primary coil 12b is similar to the widths W2 and W4 of the second and fourth winding portions 60 and 70. The second primary coil 12b is wound outside the second winding portion 60 over substantially the entire width of the second winding portion 60. The second primary coil 12b is wound outside the fourth winding portion 70 over substantially the entire width of the fourth winding portion 70.

In the circuit diagram of FIG. 3, the first primary coil 12a is depicted as having a structure in which the coil wound around the forward iron core 10f and the coil wound around the reverse iron core 10r are connected in parallel. The depicted structure is logically equivalent to that described by stating that “the first primary coil 12a is wound outside the first and third winding portions 58 and 60”. The second primary coil 12b is depicted as having a structure in which the coil wound around the forward iron core 10f and the coil wound around the reverse iron core 10r are connected in parallel. The depicted structure is logically equivalent to that described by stating that “the second primary coil 12b is wound outside the second and fourth winding portions 60 and 70”.

As shown in FIG. 3, the first terminal of the first primary coil 12a is connected to the positive-side input electrode 18, and the second terminal of the first primary coil 12a is connected to the negative-side input electrode 20. The first terminal of the second primary coil 12b is connected to the positive-side input electrode 18, and the second terminal of the second primary coil 12b is connected to the negative-side input electrode 20. The manner of connection of the first and second primary coils 12a and 12b to the positive-side and negative-side input electrodes 18 and 20 is defined so that a change in the voltage between the positive-side and negative-side input electrodes 18 and 20 causes the first and second primary coils 12a and 12b to generate magnetic fields acting in the same direction in the forward iron core 10f. The manner of connection of the first and second primary coils 12a and 12b to the positive-side and negative-side input electrodes 18 and 20 is defined so that a change in the voltage between the positive-side and negative-side input electrodes 18 and 20 causes the first and second primary coils 12a and 12b to generate magnetic fields acting in the same direction in the reverse iron core 10r. Upon a change in the voltage between the positive-side and negative-side input electrodes 18 and 20, magnetic fields acting in the same direction are generated in the forward and reverse iron cores 10f and 10r (for example, clockwise magnetic fields are generated in the iron cores 10f and 10r as viewed from the right in FIG. 1).

As shown in FIG. 3, the first terminal of the first rectifying element 22 is connected to the first terminal 64 of the forward secondary coil 14f. The first terminal of the second rectifying element 24 is connected to the first terminal 74 of the reverse secondary coil 14r. The second terminals of the first and second rectifying elements 22 and 24 are both connected to the output electrode 26. In this embodiment, both the first and second rectifying elements 22 and 24 are diodes. The rectifying elements may be switching elements such as MOSFETs. In this case, one of the two switching elements is in the conducting state, while the other switching element is in the non-conducting state. The switching elements are switchable between the conducting and non-conducting states. As previously stated, the first and second rectifying elements 22 and 24 and the output electrode 26 are not illustrated in FIG. 1.

The top cover 4 covers the two iron cores 10, two secondary coils 14, and two primary coils 12 from above. The top cover 4 is made of a non-magnetic, thermally conductive metal or non-magnetic, thermally conductive ceramic. Preferred examples of the material of the top cover 4 include aluminum alloys, alumina, and magnesium oxide. The top cover 4 may contain a cooling liquid therein. A typical example of the cooling liquid is water.

On the bottom cover 6 are mounted the two iron cores 10, two secondary coils 14, and two primary coils 12. As previously stated, the base portion 78 of the reference electrode 16 is buried in the bottom cover 6. The bottom cover 6 is made of a thermally conductive material. In this embodiment, the bottom cover 6 is electrically conductive and connected to the reference electrode 16. Preferred examples of the material of the bottom cover 6 include aluminum alloys. The bottom cover 6 may be made of an insulating material. The bottom cover 6 may contain a cooling liquid therein. A typical example of the cooling liquid is water.

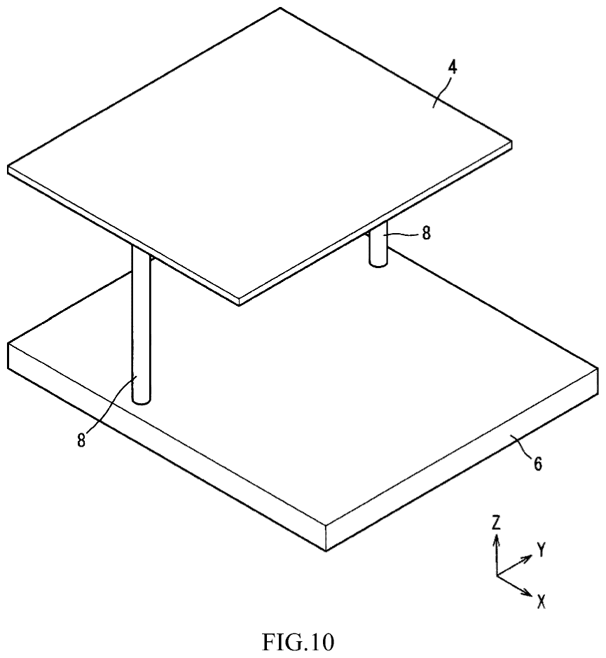

FIG. 10 shows the top cover 4, bottom cover 6, and joints 8. There are two joints 8 in this embodiment. The joints 8 are located between the top and bottom covers 4 and 6. The joints 8 connect the top and bottom covers 4 and 6. The joints 8 are made of a non-magnetic, thermally conductive metal or non-magnetic, thermally conductive ceramic. Preferred examples of the material of the joints 8 include aluminum alloys, alumina, and magnesium oxide. The joints 8 may contain a cooling liquid therein. A typical example of the cooling liquid is water.

The following will describe the operation of the transformer 2.

In this embodiment, as shown in FIG. 3, the AC power supply 25 is connected between the positive-side and negative-side input electrodes 18 and 20 of the transformer 2. For example, in case that the voltage of the positive-side input electrode 18 changes and becomes higher than the voltage of the negative-side input electrode 20, the amounts of the currents flowing through the first and second primary coils 12a and 12b change, and this leads to changes in the magnetic fluxes in the forward and reverse iron cores 10f and 10r. Induced electromotive forces are accordingly generated in the forward and reverse secondary coils 14f and 14r. Since the forward and reverse secondary coils 14f and 14r are wound in opposite directions, voltages acting in opposite directions are generated in the forward and reverse secondary coils 14f and 14r. A forward voltage is applied to one of the first and second rectifying elements 22 and 24, and a reverse voltage is applied to the other of the first and second rectifying elements 22 and 24. Thus, for example, the first rectifying element 22 is brought into the conducting state, while the second rectifying element 24 is brought into the non-conducting state. The output voltage of the forward secondary coil 14f appears at the output electrode 26. The reverse secondary coil 141 is isolated from the output electrode 26, and energy arising from the induced electromotive force is stored in the reverse secondary coil 14r.

In case that the voltage of the positive-side input electrode 18 subsequently changes and becomes lower than the voltage of the negative-side input electrode 20, the forward and reverse iron cores 10f and 10r undergo magnetic flux changes which are opposite to those in the case described above. The directions of the voltages generated in the forward and reverse secondary coils 14f and 14r are opposite to those in the case described above. A reverse voltage is applied to the first rectifying element 22, and a forward voltage is applied to the second rectifying element 24. The output voltage of the reverse secondary coil 14r appears at the output electrode 26. The voltage generated is high due to the energy arising from the induced electromotive force and the previously stored energy. The forward secondary coil 14f is isolated from the output electrode 26, and the energy arising from the induced electromotive force is stored in the forward secondary coil 14f.

In the transformer 2, a voltage is output to the output electrode 26 from one of the forward and reverse secondary coils 14f and 14r, and energy is stored in the other secondary coil 14. Voltage output to the output electrode 26 and energy storage are repeated in each of the forward and reverse secondary coils 14f and 14r. This circuit operates as a single-phase full-wave rectifier.

The following will describe advantageous effects of the present embodiment.

In the transformer 2 according to the present disclosure, the reference electrode 16 to which both the forward and reverse secondary coils 14f and 14r are connected is in the form of a plate. Heat generation is likely to occur in the forward and secondary coil 14f, reverse secondary coil 14r, forward iron core 10f, and reverse iron core 10r which undergo repeated energy storage and energy release. In the plate-shaped reference electrode 16, the cross-sectional area contributing to thermal conduction and the surface area contributing to heat release can easily be increased. The reference electrode 16 makes an effective contribution to heat discharge from the iron cores 10 and secondary coils 14. In the transformer 2, heat generation-induced temperature rise is reduced by a simple configuration.

In this embodiment, the reference electrode 16 is located between the forward and reverse iron cores 10f and 10r and between the forward and reverse secondary coils 14f and 14r. With the plate-shaped reference electrode 16 located between the forward and reverse iron cores 10f and 10r and between the forward and reverse secondary coils 14f and 14r, heat generated in these cores and coils can be discharged effectively. In the transformer 2, heat generation-induced temperature rise is reduced by a simple configuration.

In this embodiment, the reference electrode 16 includes the projecting portion 88 projecting outward from the space between the forward and reverse iron cores 10f and 10r. The projecting portion 88 effectively promotes the heat release of the reference electrode 16. In the transformer 2, heat generation-induced temperature rise is reduced by a simple configuration. Additionally, since the projecting portion 88 is spaced from the two iron cores 10 and two secondary coils 14, the projecting portion 88 does not cause an increase in inductance of the reference electrode 16. In the reference electrode 16, a low inductance is achieved.

In this embodiment, the base portion 78 of the reference electrode 16 extends along the fourth pillar portions 42 and 56 of the forward and reverse iron cores 10f and 10r. The direction of the current flowing through the base portion 78 of the reference electrode 16 is parallel to the directions of the magnetic fluxes of the forward and reverse iron cores 10f and 10r. The current of the reference electrode 16 does not affect the magnetic fluxes of the forward and reverse iron cores 10f and 10r. In the transformer 2, a high power density is achieved.

In this embodiment, the forward iron core 10f includes the cut portions 48 in the first and second pillar portions 34 and 36. The cut portion 48 of the first pillar portion 34 is covered by the first winding portion 58 of the forward secondary coil 14f. The cut portion 48 of the second pillar portion 36 is covered by the second winding portion 60 of the forward secondary coil 14f. Thus, leakage of the magnetic flux in the forward iron core 10f is effectively prevented. Likewise, the cut portion of the first pillar portion 50 of the reverse iron core 10r is covered by the third winding portion 68 of the reverse secondary coil 14r. The cut portion of the second pillar portion 52 of the reverse iron core 10r is covered by the fourth winding portion 70 of the reverse secondary coil 14r. Thus, leakage of the magnetic flux in the reverse iron core 10r is effectively prevented. In the transformer 2, a high power density is achieved.

In this embodiment, the connection portion 62 of the forward secondary coil 14f extends parallel to the third and fourth pillar portions 40 and 42 of the forward iron core 10f. The direction of the current flowing through the connection portion 62 is parallel to the direction of the magnetic flux of the forward iron core 10f. The current of the connection portion 62 does not affect the magnetic flux of the forward iron core 10f. In the transformer 2, a high power density is achieved.

In this embodiment, the connection portion 72 of the reverse secondary coil 14r extends parallel to the third and fourth pillars portions 54 and 56 of the reverse iron core 10r. The direction of the current flowing through the connection portion 72 is parallel to the direction of the magnetic flux of the reverse iron core 10r. The current of the connection portion 72 does not affect the magnetic flux of the reverse iron core 10r. In the transformer 2, a high power density is achieved.

In this embodiment, the first primary coil 12a is wound outside the first winding portion 58 over substantially the entire width of the first winding portion 58. The first primary coil 12a is wound outside the third winding portion 68 over substantially the entire width of the third winding portion 68. Thus, a high coefficient of coupling between the first primary coil 12a and the forward and reverse secondary coils 14f and 14r is achieved. In the transformer 2, a high power density is achieved.

In this embodiment, the second primary coil 12b is wound outside the second winding portion 60 over substantially the entire width of the second winding portion 60. The second primary coil 12b is wound outside the fourth winding portion 70 over substantially the entire width of the fourth winding portion 70. Thus, a high coefficient of coupling between the second primary coil 12b and the forward and reverse secondary coils 14f and 14r is achieved. In the transformer 2, a high power density is achieved.

The forward iron core 10f and the forward secondary coil 14f are preferably in indirect contact with each other, with a thermally conductive insulator interposed between the forward iron core 10f and the forward secondary coil 14f. In this case, heat generated in the forward iron core 10f can be effectively discharged through the forward secondary coil 14f. The reverse iron core 10r and the reverse secondary coil 14r are preferably in indirect contact with each other, with a thermally conductive insulator interposed between the reverse iron core 10r and the reverse secondary coil 14r. In this case, heat generated in the reverse iron core 10r can be effectively discharged through the reverse secondary coil 14r. In the transformer 2, heat generation-induced temperature rise is reduced by a simple configuration.

In this embodiment, each of the top and bottom covers 4 and 6 is made of a thermally conductive material. The top and bottom covers 4 and 6 effectively discharge heat transferred from the iron cores 10 and secondary coils 14. Further, there are the joints 8 connecting the top and bottom covers 4 and 6. The joints 8 are made of a thermally conductive material. The joints 8 make an effective contribution to heat discharge. In the transformer 2, heat generation-induced temperature rise is reduced by a simple configuration.

At least one of the top cover 4, the bottom cover 6, and the joints 8 preferably contains a cooling liquid therein. In this case, heat is discharged more effectively. In the transformer 2, heat generation-induced temperature rise is reduced by a simple configuration.

In this embodiment, when viewed in plan, the forward and reverse iron cores 10f and 10r are arranged side by side and parallel to each other, the first and third winding portions 58 and 68 are arranged side by side, and the second and fourth winding portions 60 and 70 are arranged side by side. Thus, the first primary coil 12a covering the first and third winding portions 58 and 68 can be small in size. The second primary coil 12b covering the second and fourth winding portions 60 and 70 can be small in size. In the transformer 2, downsizing is achieved.

In this embodiment, when viewed in plan, the forward and reverse secondary coils 14f and 14r are symmetrical in shape about a line extending in the front-back direction and bisecting the distance between the forward and reverse secondary coils 14f and 14r. Thus, the output voltages from the forward and reverse secondary coils 14f and 14r have waveforms precisely inverse to each other. Further, in the transformer 2, as shown in FIG. 2, the assembly of the forward iron core 10f, reverse iron core 10r, first primary coil 12a, second primary coil 12b, forward secondary coil 14f, and reverse secondary coil 14r is bilaterally symmetrical in shape when viewed in plan. Thus, the output voltages from the forward and reverse secondary coils 14f and 14r have waveforms more precisely inverse to each other. In the transformer 2, precise full-wave rectification can be achieved.

In the embodiment described above, the pair of forward iron core 10f and forward secondary coil 14f and the pair of reverse iron core 10r and reverse secondary coil 14r are arranged side by side when viewed in plan. The pair of forward iron core 10f and forward secondary coil 14f and the pair of reverse iron core 10r and reverse secondary coil 14r need not be arranged side by side. For example, these pairs may be arranged in such a manner that the forward and reverse iron cores 10f and 10r are perpendicular to each other. In the transformer 2, the positions of the pair of forward iron core 10f and forward secondary coil 14f and the pair of reverse iron core 10r and reverse secondary coil 14r can be defined so that the pairs form a shape suitable for the place where the transformer 2 is to be installed.

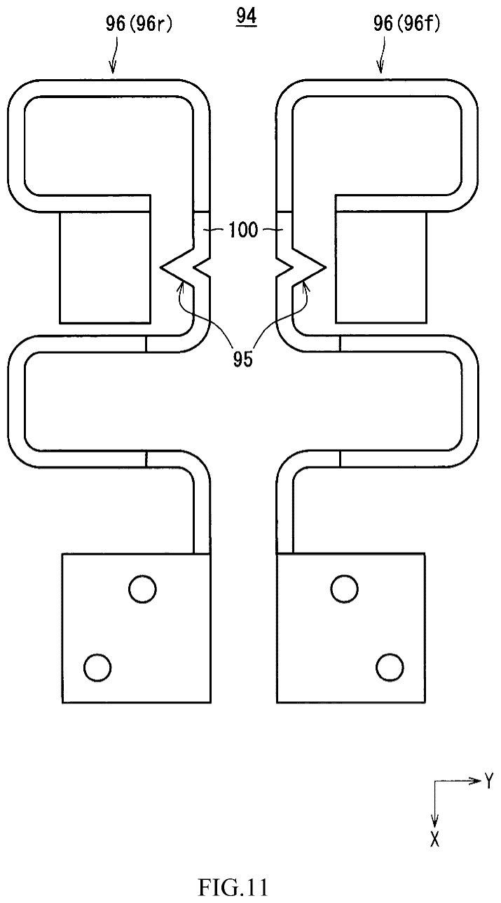

FIG. 11 is a plan view showing secondary coils 96 of a transformer 94 according to another embodiment. As shown in FIG. 11, each of the forward and reverse secondary coils 96f and 96r includes a kink 98 in a connection portion 100. The forward and reverse secondary coils 96f and 96r are likely to generate heat because of high currents flowing through the coils 96f and 96r. The forward and reverse secondary coils 96f and 96r could be deformed due to thermal expansion. Deformation of the forward or reverse secondary coil 96f or 961 could lead to contact of the coil 96f or 96r with a neighboring component. In each secondary coil 96 including the kink 98, the kink 98 is deformed due to thermal expansion, and thus deformation of the rest of the coil 96 is reduced. The kink 98 is not limited to being included in the connection portion 100. The kink 98 may be included in a portion other than the connection portion 100.

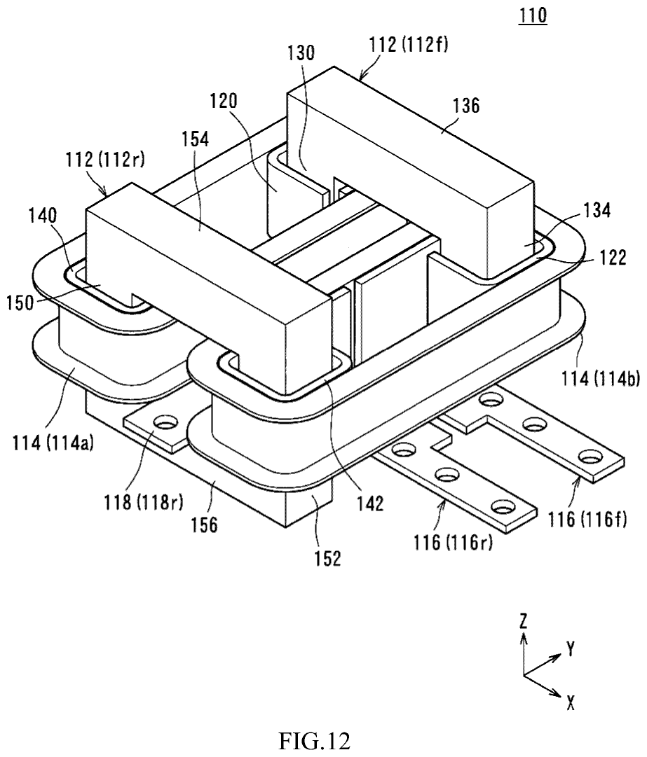

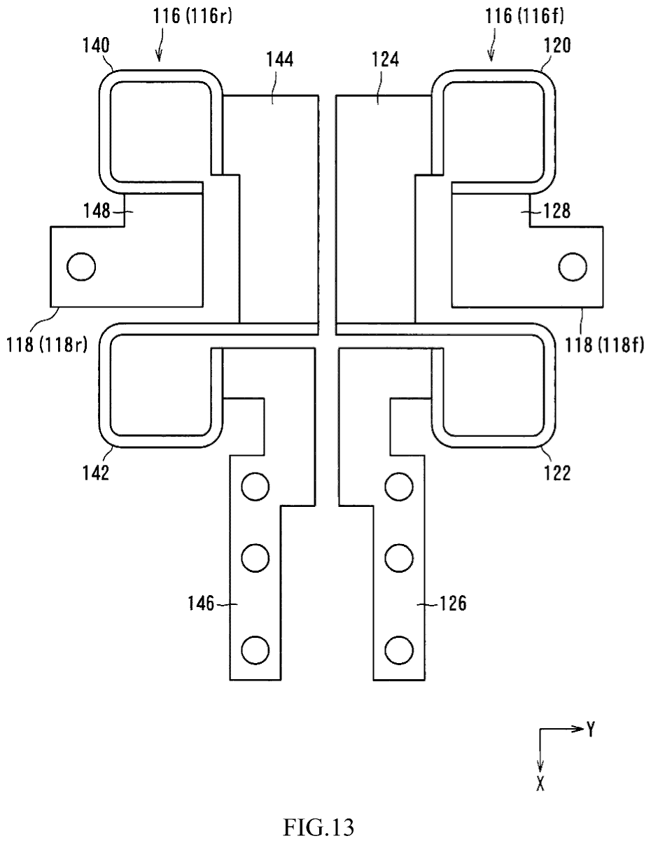

FIG. 12 is a perspective view showing iron cores 112, primary coils 114, secondary coils 116, and reference electrodes 118 of a transformer 110 according to yet another embodiment. Although not shown, the transformer 110 further includes covers covering the cores, coils, and electrodes. In FIG. 12, the arrow X represents the frontward direction with respect to the transformer 110, and the opposite direction is the backward direction with respect to the transformer 110. The arrow Y represents the rightward direction with respect to the transformer 110, and the opposite direction is the leftward direction with respect to the transformer 110. The arrow Z represents the upward direction with respect to the transformer 110, and the opposite direction is the downward direction with respect to the transformer 110. FIG. 13 is a plan view showing the secondary coils 116 and reference electrodes 118 of FIG. 12.

As shown in FIGS. 12 and 13, the transformer 110 includes two iron cores 112, two secondary coils 116, two primary coils 114, and two reference electrodes 118. The iron cores 112 and primary coils 114 are the same as the iron cores 10 and primary coils 12 of the transformer 2 of FIG. 1. One of the two secondary coils 116 is referred to as “forward secondary coil 116f”, and the other secondary coil 116 is referred to as “reverse secondary coil 116r”. The reference electrode 118 connected to the forward secondary coil 116f is referred to as “forward reference electrode 118f”, and the reference electrode 118 connected to the reverse secondary coil 116r is referred to as “reverse reference electrode 118r”.

As shown in FIG. 13, the forward secondary coil 116f includes a first winding portion 120, a second winding portion 122, a connection portion 124, a first terminal 126, and a second terminal 128. Each of the first and second winding portions 120 and 122 is a wound conductor in the form of a plate. The first winding portion 120 is wound around a first pillar portion 130 of the forward iron core 112f. Although not shown, the first winding portion 120 covers a cut portion of the first pillar portion 130. The second winding portion 122 is wound around a second pillar portion 134 of the forward iron core 112f. The second winding portion 122 covers a cut portion of the second pillar portion 134.

The connection portion 124 connects the first and second winding portions 120 and 122. The connection portion 124 extends parallel to third and fourth pillar portions 136 and 138 of the forward iron core 112f. The connection portion 124 is in the form of a plate. The width direction of the connection portion 124 is the right-left direction (the direction from the forward secondary coil 116f to the reverse secondary coil 116r), and the connection portion 124 extends in the direction from the first winding portion 120 to the second winding portion 122.

The first terminal 126 is in the form of a plate. The first terminal 126 projects ahead of the second winding portion 122. The second terminal 128 is in the form of a plate. The second terminal 128 is located between the first and second winding portions 120 and 122. The second terminal 128, first winding portion 120, connection portion 124, second winding portion 122, and first terminal 126 are connected in series in this order.

As shown in FIG. 13, the reverse secondary coil 1161 includes a third winding portion 140, a fourth winding portion 142, a connection portion 144, a first terminal 146, and a second terminal 148. Each of the third and fourth winding portions 140 and 142 is a wound conductor in the form of a plate. As shown in FIG. 12, the third winding portion 140 is wound around a first pillar portion 150 of the reverse iron core 112r. Although not shown, the third winding portion 140 covers a cut portion of the first pillar portion 150. The fourth winding portion 142 is wound around a second pillar portion 152 of the reverse iron core 112r. The fourth winding portion 142 covers a cut portion of the second pillar portion 152.

The connection portion 144 connects the third and fourth winding portions 140 and 142. The connection portion 144 extends parallel to third and fourth pillar portions 154 and 156 of the reverse iron core 112r. The connection portion 144 is in the form of a plate. The width direction of the connection portion 144 is the right-left direction (the direction from the forward secondary coil 116f to the reverse secondary coil 116r), and the connection portion 144 extends in the direction from the third winding portion 140 to the fourth winding portion 142.

The first terminal 146 is in the form of a plate. The first terminal 146 projects ahead of the fourth winding portion 142. The second terminal 148 is in the form of a plate. The second terminal 148 is located between the third and fourth winding portions 140 and 142. The second terminal 148, third winding portion 140, connection portion 144, fourth winding portion 142, and first terminal 146 are connected in series in this order.

The forward reference electrode 118f is located between the first and second winding portions 120 and 122 as shown in FIG. 13. The forward reference electrode 118f projects from the space between the first and second winding portions 120 and 122 toward the outside of the transformer 110. The forward reference electrode 118f is in the form of a plate. The forward reference electrode 118f is in contact with the second terminal 128 of the forward secondary coil 116f. In this embodiment, the forward reference electrode 118f is integral with the second terminal 128.

The reverse reference electrode 118r is located between the third and fourth winding portions 140 and 142 as shown in FIG. 13. The reverse reference electrode 1181 projects from the space between the third and fourth winding portions 140 and 142 toward the outside of the transformer 110. The reverse reference electrode 118r is in the form of a plate. The reverse reference electrode 118r is in contact with the second terminal 148 of the reverse secondary coil 116r. In this embodiment, the reverse reference electrode 118r is integral with the second terminal 148.

As shown in FIGS. 12 and 13, the transformer 110 includes the two reference electrodes 118. Both of the two reference electrodes 118 are connected to the same terminal of an external load. The forward and reverse reference electrodes 118f and 118r are connected to each other outside the transformer 110. When the transformer 110 is in use, the circuit of the transformer 110 is equivalent to the circuit diagram shown in FIG. 3.

In the transformer 110 according to the present disclosure, the forward reference electrode 118f to which the forward secondary coil 116f is connected is in the form of a plate. Further, the reverse reference electrode 118r to which the reverse secondary coil 116r is connected is also in the form of a plate. In the plate-shaped reference electrodes 118, the cross-sectional areas contributing to thermal conduction and the surface areas contributing to heat release can easily be increased. The reference electrodes 118 make an effective contribution to heat discharge from the iron cores 112 and secondary coils 116. In the transformer 110, heat generation-induced temperature rise is reduced by a simple configuration.

In this embodiment, the transformer 110 includes the forward and reverse reference electrodes 118f and 118r. These electrodes are not connected inside the transformer 110. For example, in the case where there is a large reference electrode (ground) such as a housing of a device, the forward and reverse reference electrodes 118f and 118r can easily be connected to the large reference electrode. Since the forward and reverse reference electrodes 118f and 118r are not connected inside the transformer 110, the structure of the transformer 110 is simple. The transformer 110 can be small in size.

In this embodiment, the connection portion 124 of the forward secondary coil 116f is in the form of a plate. The connection portion 124 contributes to heat discharge. The width direction of the connection portion 124 is the direction from the forward secondary coil 116f to the reverse secondary coil 116r. The width of the connection portion 124 can be adjusted by adjusting the distance between the forward and reverse secondary coils 116f and 116r. In the transformer 110, the heat discharge performance can easily be adjusted. In the transformer 110, heat generation-induced temperature rise is reduced by a simple configuration.

In this embodiment, the connection portion 144 of the reverse secondary coil 116r is in the form of a plate. The connection portion 144 contributes to heat discharge. The width direction of the connection portion 144 is the direction from the forward secondary coil 116f to the reverse secondary coil 116r. The width of the connection portion 144 can be adjusted by adjusting the distance between the forward and reverse secondary coils 116f and 116r. In the transformer 110, the heat discharge performance can easily be adjusted. In the transformer 110, heat generation-induced temperature rise is reduced by a simple configuration.

As described above, the present disclosure can provide a current-doubler transformer in which heat generation-induced temperature rise is reduced by a simple configuration. This clearly demonstrates the superiority of the transformer.

The transformer as described above is applicable to various kinds of electric devices such as AC-DC converters and DC-DC converters.

[Disclosed Items]

The following items are directed to preferred embodiments.

[Item 1]

A transformer including:

a positive-side input electrode;

a negative-side input electrode;

an output electrode;

a single reference electrode or a plurality of reference electrodes;

a forward iron core;

a reverse iron core;

a first primary coil;

a second primary coil;

a forward secondary coil;

a reverse secondary coil;

a first rectifying element; and

a second rectifying element, wherein:

a first terminal of the first primary coil is connected to the positive-side input electrode, and a second terminal of the first primary coil is connected to the negative-side input electrode;

a first terminal of the second primary coil is connected to the positive-side input electrode, and a second terminal of the second primary coil is connected to the negative-side input electrode;

a first terminal of the forward secondary coil is connected to a first terminal of the first rectifying element, and a second terminal of the forward secondary coil is connected to the single reference electrode or any of the plurality of reference electrodes;

a first terminal of the reverse secondary coil is connected to a first terminal of the second rectifying element, and a second terminal of the reverse secondary coil is connected to the single reference electrode or any of the plurality of reference electrodes;

second terminals of the first and second rectifying elements are connected to the output electrode;

the forward secondary coil includes first and second winding portions both of which are wound around the forward iron core;

the reverse secondary coil includes third and fourth winding portions both of which are wound around the reverse iron core;

the first primary coil is formed around the first and third winding portions;

the second primary coil is formed around the second and fourth winding portions;

the single reference electrode or each of the plurality of reference electrodes is in the form of a plate;

winding directions of the first and second primary coils and the first, second, third, and fourth winding portions are defined so that voltages inverse to each other are generated at the respective first terminals of the forward and reverse secondary coils upon a change in a voltage applied between the positive-side and negative-side input electrodes; and

the voltage of the first terminal of the forward or reverse secondary coil is output through the output electrode by bringing one of the first and second rectifying elements into a conducting state while bringing the other of the first and second rectifying elements into a non-conducting state.

[Item 2]

The transformer according to Item 1, wherein:

the forward iron core includes a cut portion; and

the first or second winding portion is wound around the forward iron core to cover the cut portion.

[Item 3]

The transformer according to Item 1, wherein:

the forward iron core is in the form of a frame having outer and inner peripheral surfaces with rectangular contours and includes opposing first and second pillar portions extending parallel to each other and opposing third and fourth pillar portions extending parallel to each other;

the first winding portion is wound around the first pillar portion; and

the second winding portion is wound around the second pillar portion.

[Item 4]

The transformer according to Item 3, wherein:

the forward secondary coil further includes a connection portion connecting the first and second winding portions; and

the connection portion extends parallel to the third and fourth pillar portions.

[Item 5]

The transformer according to Item 4, wherein the connection portion is in the form of a plate.

[Item 6]

The transformer according to Item 3, including the single reference electrode, wherein:

the single reference electrode includes a base portion, a first extraction portion connected to the second terminal of the forward secondary coil, and a second extraction portion connected to the second terminal of the reverse secondary coil; and

the base portion extends along the fourth pillar portion.

[Item 7]

The transformer according to Item 1, including the single reference electrode, wherein the single reference electrode is located between the forward and reverse iron cores and between the forward and reverse secondary coils when viewed in plan.

[Item 8]

The transformer according to Item 7, wherein the reference electrode includes a projecting portion projecting outward from a space between the forward and reverse iron cores.

[Item 9]

The transformer according to Item 1, including a forward reference electrode and a reverse reference electrode, wherein:

the second terminal of the forward secondary coil is connected to the forward reference electrode;

the second terminal of the reverse secondary coil is connected to the reverse reference electrode;

the forward reference electrode projects outward from a space between the first and second winding portions; and

the reverse reference electrode projects outward from a space between the third and fourth winding portions.

[Item 10]

The transformer according to Item 1, wherein the forward secondary coil includes a kink.

[Item 11]

The transformer according to Item 1, wherein:

each of the first and second winding portions is a wound conductor in the form of a plate;

the first primary coil is wound outside the first winding portion over substantially the entire width of the first winding portion; and

the second primary coil is wound outside the second winding portion over substantially the entire width of the second winding portion.

[Item 12]

The transformer according to Item 1, wherein the forward iron core and the forward secondary coil are in indirect contact with each other, with a thermally conductive insulator interposed between the forward iron core and the forward secondary coil.

[Item 13]

The transformer according to Item 1, wherein when viewed in plan, the forward and reverse iron cores are arranged side by side and parallel to each other, the first and third winding portions are arranged side by side, and the second and fourth winding portions are arranged side by side.

[Item 14]

The transformer according to Item 13, wherein the forward and reverse secondary coils are symmetrical in shape when viewed in plan.

[Item 15]

The transformer according to Item 1, further including:

a top cover made of a thermally conductive material;

a bottom cover made of a thermally conductive material; and

a joint made of a thermally conductive material, wherein:

the forward and reverse iron cores, the first and second primary coils, and the forward and reverse secondary coils are located between the top and bottom covers; and

the top and bottom covers are connected by the joint.

[Item 16]

The transformer according to Item 15, wherein at least one of the top cover, the bottom cover, and the joint contains a cooling liquid therein.

[Item 17]

The transformer according to Item 15, wherein the bottom cover is electrically conductive and connected to the reference electrode.

What is claimed is:

1. A transformer comprising:
a positive-side input electrode;
a negative-side input electrode;
an output electrode;
a single reference electrode or a plurality of reference electrodes;
a forward iron core;
a reverse iron core;
a first primary coil;
a second primary coil;
a forward secondary coil;
a reverse secondary coil;
a first rectifying element; and
a second rectifying element, wherein:
a first terminal of the first primary coil is connected to the positive-side input electrode, and a second terminal of the first primary coil is connected to the negative-side input electrode;
a first terminal of the second primary coil is connected to the positive-side input electrode, and a second terminal of the second primary coil is connected to the negative-side input electrode;
a first terminal of the forward secondary coil is connected to a first terminal of the first rectifying element, and a second terminal of the forward secondary coil is connected to the single reference electrode or any of the plurality of reference electrodes;
a first terminal of the reverse secondary coil is connected to a first terminal of the second rectifying element, and a second terminal of the reverse secondary coil is connected to the single reference electrode or any of the plurality of reference electrodes;
second terminals of the first and second rectifying elements are connected to the output electrode;
the forward secondary coil includes first and second winding portions both of which are wound around the forward iron core;
the reverse secondary coil includes third and fourth winding portions both of which are wound around the reverse iron core;
the first primary coil is formed around the first and third winding portions;
the second primary coil is formed around the second and fourth winding portions;
the single reference electrode or each of the plurality of reference electrodes is in the form of a plate;
winding directions of the first and second primary coils and the first, second, third, and fourth winding portions are defined so that voltages inverse to each other are generated at the respective first terminals of the forward and reverse secondary coils upon a change in a voltage applied between the positive-side and negative-side input electrodes; and
the voltage of the first terminal of the forward or reverse secondary coil is output through the output electrode by bringing one of the first and second rectifying elements into a conducting state while bringing the other of the first and second rectifying elements into a non-conducting state.

2. The transformer according to claim 1, wherein:
the forward iron core includes a cut portion; and
the first or second winding portion is wound around the forward iron core to cover the cut portion.

3. The transformer according to claim 1, wherein:
the forward iron core is in the form of a frame having outer and inner peripheral surfaces with rectangular contours and includes opposing first and second pillar portions extending parallel to each other and opposing third and fourth pillar portions extending parallel to each other;
the first winding portion is wound around the first pillar portion; and
the second winding portion is wound around the second pillar portion.

4. The transformer according to claim 3, wherein:
the forward secondary coil further includes a connection portion connecting the first and second winding portions; and
the connection portion extends parallel to the third and fourth pillar portions.

5. The transformer according to claim 4, wherein the connection portion is in the form of a plate.

6. The transformer according to claim 3, comprising the single reference electrode, wherein:
the single reference electrode includes a base portion, a first extraction portion connected to the second terminal of the forward secondary coil, and a second extraction portion connected to the second terminal of the reverse secondary coil; and
the base portion extends along the fourth pillar portion.

7. The transformer according to claim 1, comprising the single reference electrode, wherein the single reference electrode is located between the forward and reverse iron cores and between the forward and reverse secondary coils when viewed in plan.

8. The transformer according to claim 7, wherein the reference electrode includes a projecting portion projecting outward from a space between the forward and reverse iron cores.

9. The transformer according to claim 1, comprising a forward reference electrode and a reverse reference electrode, wherein:
the second terminal of the forward secondary coil is connected to the forward reference electrode;
the second terminal of the reverse secondary coil is connected to the reverse reference electrode;
the forward reference electrode projects outward from a space between the first and second winding portions; and
the reverse reference electrode projects outward from a space between the third and fourth winding portions.

10. The transformer according to claim 1, wherein the forward secondary coil includes a kink.

11. The transformer according to claim 1, wherein:
each of the first and second winding portions is a wound conductor in the form of a plate;
the first primary coil is wound outside the first winding portion over substantially the entire width of the first winding portion; and
the second primary coil is wound outside the second winding portion over substantially the entire width of the second winding portion.

12. The transformer according to claim 1, wherein the forward iron core and the forward secondary coil are in indirect contact with each other, with a thermally conductive insulator interposed between the forward iron core and the forward secondary coil.

13. The transformer according to claim 1, wherein when viewed in plan, the forward and reverse iron cores are arranged side by side and parallel to each other, the first and third winding portions are arranged side by side, and the second and fourth winding portions are arranged side by side.

14. The transformer according to claim 13, wherein the forward and reverse secondary coils are symmetrical in shape when viewed in plan.

15. The transformer according to claim 1, further comprising:
a top cover made of a thermally conductive material;
a bottom cover made of a thermally conductive material; and
a joint made of a thermally conductive material, wherein:
the forward and reverse iron cores, the first and second primary coils, and the forward and reverse secondary coils are located between the top and bottom covers; and
the top and bottom covers are connected by the joint.

16. The transformer according to claim 15, wherein at least one of the top cover, the bottom cover, and the joint contains a cooling liquid therein.

17. The transformer according to claim 15, wherein the bottom cover is electrically conductive and connected to the reference electrode.
